(19) United States
(12) Patent Application Publication
(10) Pub. No.: US 2016/0367337 A1
(43) Pub. Date: Dec. 22, 2016

(54) DENTAL INSTRUMENT

(71) Applicant: GEBR. BRASSELER GMBH & CO. KG, Lemgo (DE)

(72) Inventor: Karl-Heinz DANGER, Detmold (DE)

(21) Appl. No.: 15/121,182

(22) PCT Filed: Jan. 26, 2015
(86) PCT No.: PCT/EP2015/051497

§ 371 Date: Aug. 24, 2016

(30) Foreign Application Priority Data
Feb. 26, 2014 (DE) 10 2014 203 451.5

(51) Int. Cl. A61C 3/02

(52) U.S. Cl. CPC A61C 3/02

(57) ABSTRACT

The invention relates to a dental instrument having a shaft and, connected to the latter, a head which is provided with cutting edges, characterized in that smooth cutting edges, and cutting edges with a discontinuous cutting edge contour, are formed about the circumference of the head.

The invention relates to a dental instrument with a shaft and, connected to the latter, a head which is provided with cutting edges.

Dental instruments of the kind described are already known in very different design variants. A classical design variant is a so-called rosehead bur, which is suitable for the removal of carious tissue.

In dental instruments, it is desirable that the instrument allows work to be carried out with low vibrations and that at the same time a high rate of material removal is ensured. This is not always the case in the instruments known from the prior art.

The object of the invention is to make available a dental instrument which is of the kind mentioned at the outset and which, while having a simple structure and being able to be produced easily and cost-effectively, permits low-vibration use and has a high rate of material removal.

According to the invention, the object is achieved by the combination of features of claim 1, while further advantageous embodiments of the invention are set forth in the dependent claims.

According to the invention, provision is thus made that smooth cutting edges, and cutting edges with a discontinuous cutting edge contour, are formed about the circumference of the head. In the instrument according to the invention, provision is thus made that smooth, conventionally designed cutting edges alternate with cutting edges whose cutting edge contour is not designed in the form of a smooth, continuously extending cutting edge. In an advantageous development of the invention, such cutting edges with a discontinuous cutting edge contour are in the form of a serrated finish. Such serrated finishes are already known from the field of knives. In the dental instrument according to the invention, individual areas of the cutting edge contour protrude radially farther than other cutting edges. Therefore, when contact is made with a surface that is to be worked, the protruding areas of the cutting edge contour are brought into engagement first. During a rotation of the instrument, a trailing, smooth cutting edge then comes into cutting engagement. It is thus possible, by means of the cutting edges with a discontinuous cutting edge contour, to initially remove quite small particles. With the smooth cutting edge following on from this, it is then possible to smooth the surface that has been worked by the discontinuous cutting edge contour in irregular areas, in order at the same time to divide the materials to be removed, such that said materials can be easily removed from the spaces between the cutting edges.

By means of the design provided according to the invention, there is a considerable reduction in the vibrations that occur. The work can be carried out almost free of vibration.

In a particularly expedient development of the invention, provision is made that the cutting edges with the discontinuous cutting edge contour are, as has been mentioned, in the form of a serrated finish. In this case, both the protruding areas and also the recessed areas of the cutting edge contour are sharp and cutting. However, according to the invention, it is also possible for the cutting edge contour to be formed by at least one cross-cut or by means of at least one cross-toothing. Here, the recessed parts of the discontinuous cutting edge contour can also be cutting, in order to withdraw the removed particles.

It is particularly expedient if smooth cutting edges and cutting edges with a discontinuous cutting edge contour are formed in alternation about the circumference of the head. Alternatively, however, it is also possible to provide groups of smooth cutting edges and groups of cutting edges with a discontinuous cutting edge contour in alternation about the circumference of the head.

To allow work to be performed with low vibrations and with a high rate of material removal, it may be expedient if the smooth cutting edges and the cutting edges with a discontinuous cutting edge contour each have different radii in a plane at right angles to the rotation axis of the head. However, it is also possible to provide identical radii.

In another preferred embodiment of the invention, provision is made that the cutting edges with the discontinuous cutting edge contour are identical along their axial length or that the discontinuous cutting edge contour changes along the axial length of the head. It is possible, for example, for some of the cutting edges with a discontinuous cutting edge contour to be provided with a coarser division or configuration than other cutting edges on the head, which other cutting edges can have a finer cutting edge contour. In the configuration as a serrated finish, it is possible, for example, to vary the radius of the serrated finish such that the individual cutting edges with the serrated finish, which are arranged on the circumference of the head, have a different serrated finish. Alternatively or in addition, it is also possible, for example in the front distal area of the instrument, to make the cutting edge contour with the serrated finish finer and thus choose the distance between the individual “waves” to be smaller than on the area of the head directed toward the shaft.

In an expedient embodiment of the invention, the dental instrument, which is designed as a rosehead bur, has, for example, four, six or eight cutting edges. It is particularly advantageous if two of these cutting edges run together at the front distal end of the bur in a transverse edge, such that the instrument according to the invention also has a high rate of material removal in the axial direction.

A further possible embodiment is one in which the cutting edges are arranged in so-called groups. For this purpose, at least two groups with at least one tooth (in the above-described configuration) would be necessary. Three or more groups would be advantageous in particular.

The dental instrument according to the invention is preferably produced either by means of an additive production method or a subtractive laser method. In the subtractive laser method, besides the shaft, the head in particular can be produced by means of the laser method from a semi-finished product or a blank. The use of a short-pulse laser or of an ultashort-pulse laser is advantageous in particular. By means of such lasers, very small volumes of material can be vaporized without compromising or altering the structure of the rest of the workpiece. In an additive method, it is possible to use direct laser deposition (DLD) or electron beam welding. A selective laser sintering method is also possible, for example. Such methods save time and are cost-effective, and they allow the head of the dental instrument according to the invention to have geometries that cannot be produced by classical grinding or milling methods.

The dental instrument according to the invention can be produced, for example, from steel, hard metal or ceramic.

The invention is described below on the basis of illustrative embodiments and with reference to the drawing, in which:

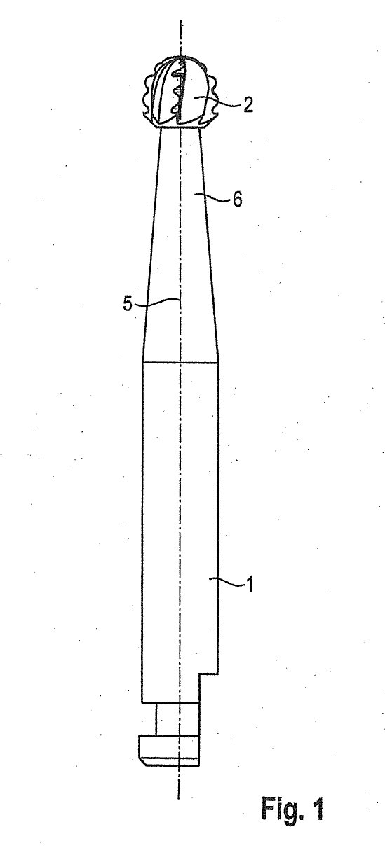

FIG. 1 shows a simplified side view of a first illustrative embodiment of a dental instrument according to the invention,

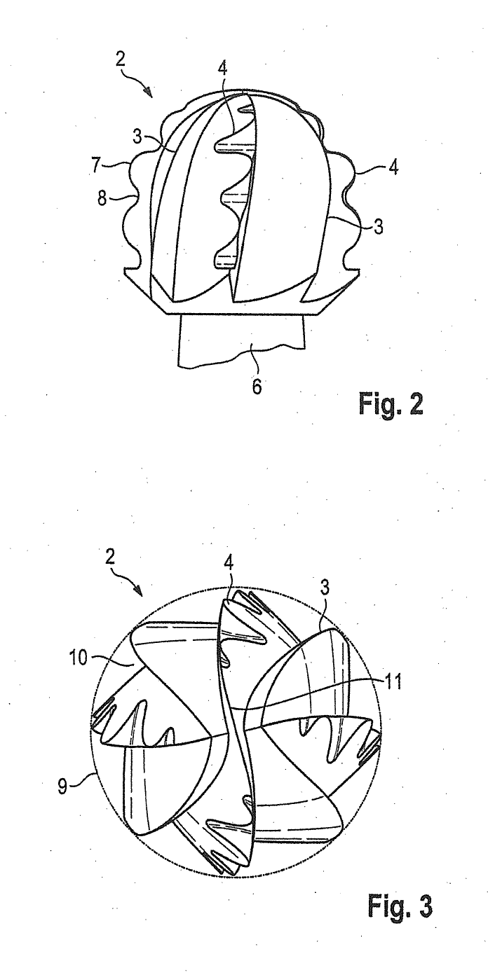

FIG. 2 shows an enlarged view of the head shown in FIG. 1,

FIG. 3 shows an enlarged front view of the head,

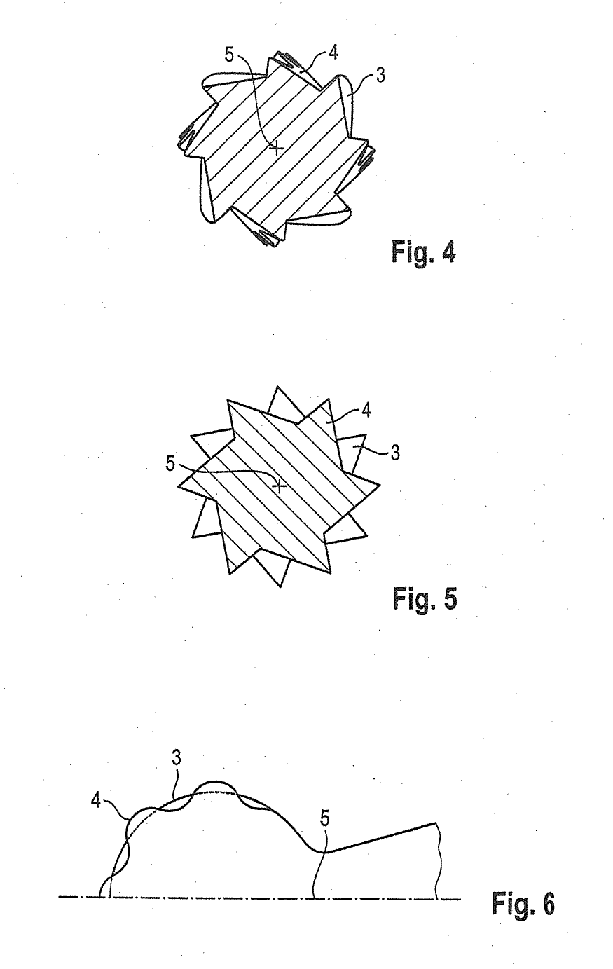

FIG. 4 shows a radial sectional view of the head shown in FIGS. 2 and 3,

FIG. 5 shows a sectional view, analogous to FIG. 4, of a further illustrative embodiment of the invention,

FIG. 6 shows a schematic side view of the illustrative embodiment shown in FIG. 5,

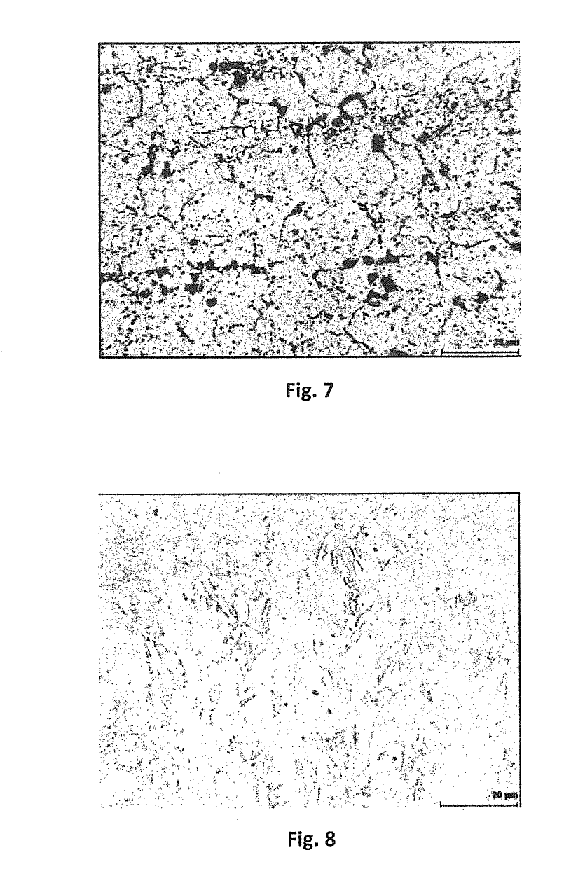

FIG. 7 shows a micrograph of the typical structure of drawn steel with subsequent heat treatment, and

FIG. 8 shows a micrograph of a material generated by an additive laser fusion method.

The dental instrument according to the invention comprises a shaft 1, which has the customary dimensions and is provided with clamping and force-transmitting means. The shaft 1 is rotatable about a central rotation axis 5. The shaft 1 is adjoined by a neck 6, on which a head 2 is formed.

As can be seen in particular from FIGS. 2 and 3, the head has, distributed about the circumference, a sequence of smooth cutting edges 3 and cutting edges 4 with a discontinuous cutting edge contour. According to the invention, the expression “smooth cutting edge” is to be understood as a cutting edge that is not interrupted and that extends continuously.

In the illustrative embodiment shown, the cutting edges 4 with a discontinuous cutting edge contour are in the form of a serrated finish. The serrated contour or the serrated finish has protruding cutting edge areas 7 and recessed cutting edge areas 8. These are continuously sharp and cutting, such that the protruding cutting edge areas 7 and also the recessed cutting edge areas 8 cause removal of material particularly in a radial movement (with respect to the rotation axis 5) of the head 2. During a rotation of the head 2, a cutting edge 4 with a discontinuous cutting edge contour is followed by a smooth cutting edge 3, as can be seen in particular from the view in FIG. 3.

FIG. 3 shows an illustrative embodiment with a total of eight cutting edges, wherein four smooth cutting edges 3 and four cutting edges 4 with a discontinuous cutting edge contour are provided in alternation. The chip space formed between the cutting edges is labeled by reference sign 10. Moreover, FIG. 3 shows that at least two of the cutting edges 4 with a discontinuous cutting edge contour run together at the front and form a chisel edge 11.

FIG. 3 shows an envelope 9 which, upon rotation of the instrument, is obtained in the respective radial sectional plane through the outer margins of the cutting edges 3, 4. The envelope 9 according to FIG. 3 has the shape of a circle. It will be seen from this that, in the illustrative embodiment shown, the respective radii of the smooth cutting edges 3 and of the protruding cutting edge areas 7 of the cutting edges 4 with a discontinuous cutting edge contour have the same radius.

FIG. 4 shows a radial sectional view of the illustrative embodiment from FIGS. 2 and 3. It will be seen from this that the teeth all have the same tooth heights and therefore the same radius. All of the teeth thus cut uniformly at the circumference with their areas raised from the serrated finish.

FIGS. 5 and 6 show a further design variant in which different teeth are provided in alternation. The teeth 4 with the discontinuous cutting edge contour (serrated finish) have a greater diameter or radius than the smooth cutting edges 3. This is illustrated in particular in FIG. 6. The cutting edges 4 with the serrated finish have a chip-removing action during the cutting process, while the smooth cutting edges 3 provide secondary work in the form of a smoothing process.

Such a design of the cutting edges is suitable not only for classical rosehead burs but also for milling cutters, which are preferably used in dentistry.

FIGS. 7 and 8 show micrographs allowing a comparison between a conventionally generated material and a material generated by means of an additive method.

The micrograph shown in FIG. 7 is that of a conventionally produced material which has the typical structure of drawn steel with subsequent heat treatment. The carbides arranged lengthwise in the martensitic matrix can be clearly seen.

FIG. 8, by contrast, shows a micrograph of a material generated by means of an additive laser fusion method. The micrograph clearly shows a coarse, martensitic structure with fine carbide dispersions, which have no particular arrangement. In additively produced workpieces, it proves advantageous that these do not form hardening cracks, as is the case in conventionally generated workpieces.

List of Reference Signs

1 shaft

2 head

3 smooth cutting edge

4 cutting edge with discontinuous cutting edge contour

5 rotation axis

6 neck

7 protruding cutting edge area

8 recessed cutting edge area

9 envelope

10 chip space

11 cross-cut

1. A dental instrument having a shaft and, connected to the latter, a head which is provided with cutting edges, wherein smooth cutting edges, and cutting edges with a discontinuous cutting edge contour, are formed about the circumference of the head.

2. The dental instrument as claimed in claim 1, wherein the cutting edges with the discontinuous cutting edge contour are in the form of a serrated finish.

3. The dental instrument as claimed in claim 1, wherein the cutting edges with the discontinuous cutting edge contour have at least one cross-cut.

4. The dental instrument as claimed in claim 1, wherein the cutting edges with the discontinuous cutting edge contour are in the form of a cross-toothing.

5. The dental instrument as claimed in claim 1, wherein smooth cutting edges, and cutting edges with a discontinuous cutting edge contour, alternate about the circumference of the head.

6. The dental instrument as claimed in claim 1, wherein groups of smooth cutting edges and groups of cutting edges with a discontinuous cutting edge contour are arranged alternately on the circumference of the head.

7. The dental instrument as claimed in claim 1, wherein the smooth cutting edges and the cutting edges with a discontinuous cutting edge contour have different radii in planes at right angles to a rotation axis of the head.

8. The dental instrument as claimed in claim 1, wherein the smooth cutting edges and the cutting edges with a discontinuous cutting edge contour have identical radii or different radii in planes at right angles to a rotation axis of the head.

9. The dental instrument as claimed in claim 1, wherein the cutting edges with a discontinuous cutting edge contour are identical or different along their axial length.

10. The dental instrument as claimed in claim 1, wherein the instrument is produced by means of an additive production method or by means of a subtractive laser method.
